(19) United States
(12) Patent Application Publication
(10) Pub. No.: US 2010/0193050 A1
(43) Pub. Date: Aug. 5, 2010

(54) SAFETY VALVE FOR A GAS CYLINDER

(75) Inventor: Eduard J. Job, Ahrensburg (DE)

Correspondence Address: SAND & SEBOLT, AEGIS TOWER, SUITE 1100, 4940 MUNSON STREET, NW, CANTON, OH, 44718-3615, US

(73) Assignee: JOB LIZENZ GMBG & CO. KG, Ahrensburg (DE)

(21) Appl. No.: 12/447,594

(22) PCT Filed: Sep. 13, 2007
(86) PCT No.: PCT/EP07/59634

§ 371 Date: Apr. 20, 2010

(30) Foreign Application Priority Data
Nov. 6, 2006 (EP) 06022995.2

(51) Int. Cl. F16K 17/38

(52) U.S. Cl. 137/468

(57) ABSTRACT

A safety valve for a pressurized gas container is disclosed having a crossflow channel (1) which is connected to the pressurized gas container and having at least one outlet channel (2) and having a thermal triggering unit (3, 101, 102) which has a closure body (101) which can be displaced from a readiness position, in which, in interaction with a sealing element (5), it keeps the crossflow channel (1) tightly closed with respect to the at least one outlet channel (2), into a release position, in which the crossflow channel (1) is connected to the outlet channel (2), and which thermal triggering unit (3, 101, 102) has a rupture body (3) which is arranged between an abutment (4) and the closure body (101), in order to hold the latter in the readiness position, wherein the thermal triggering unit (3, 101, 102) comprises a spring element (102) which exerts a spring force on the rupture body (3), which spring force is oriented in the direction of the abutment (4). Said safety valve is distinguished by the fact that the spring element (102) acts on the closure body (101), in order to exert on the latter a spring force which acts in the triggering direction. This embodiment ensures that the safety valve triggers reliably by means of the force which is exerted on the closure body (101) by the spring element (102), even in the case of a relatively low gas pressure in the crossflow line (1) and therefore a low force which acts on the closure body (101).

### TECHNICAL AREA

The invention relates to a safety valve for a gas cylinder in accordance with the generic part of claim 1.

### STATE OF THE ART

Such a safety valve is disclosed in the previously unpublished European patent application

### EP 05015968 A (JOB LIZENZ GMBH & CO. KG) Jul. 22, 2005, No. 05015968.0.

Another safety valve, and in particular formed without a spring element formed as disclosed in the generic part of claim 1, is disclosed in patent DE 19911530 C (VTI VENTIL TECHNIK GMBH), Sep. 28, 2000.

According to the technical regulations for compressed gases, e.g., TTRG381, gas cylinders must be equipped with a safety fuse or a fuse that functions in the same manner in order to reliably prevent an exceeding of pressure and therewith a bursting of the container in the case of fire.

This also applies, for example, to gas cylinders arranged in motor vehicles for receiving natural gas, hydrogen or other combustible gases as fuel.

The variant of such a safety valve previously known from the above-cited patent

DE 19911530 C (VTI VENTIL TECHNIK GMBH), Sep. 28, 2000 contains a closure body supported in a ready position directly on the metal of a housing, in which an overflow conduit is formed. The bursting body, which is a glass ampoule in this example, is, for its part, then supported directly on the closure body itself. According to the teaching disclosed in the above-cited publication the glass ampoule is in the end clamped in between two rigidly connected supports. The differences between the thermal coefficients of expansion of the metal from which the closure body as well as the housing are formed and between the glass material of the bursting body results in this arrangement to the fact that during cooling down or heating there is the danger that the bursting body breaks because, for example, the metal of the closure body and of the housing expands and contracts more strongly than the glass material of the bursting body and thus crushes it, in particular during cooling off. The problem of different temperatures and therewith different expansions of the cited materials occurs in particular in gas cylinders and in the safety valves arranged on them that are arranged in motor vehicles. Motor vehicles are exposed, in particular when they are parked or stopped outdoors, to temperatures of down to −50° C. in winter and up to 50° C. and more (if they are standing directly in the sun) in the summer, during which the cited environmental temperatures can even be dropped far below during the filling procedure of the gas cylinder. Due to this wide temperature span of 100° C. and more the different thermal coefficients of expansion the metal and glass become clearly noticeable. In other words, an unintended release of the safety valve and a flowing out of the gas present in the gas cylinder can occur. However, the same considerations regarding the thermal coefficients of expansion also apply to other gas cylinders and to the safety valves arranged in them, that are exposed to high fluctuations of temperature.

The problem of the different thermal coefficients of expansion between the material of the bursting element and that of the valve housing has already been included in the above-cited European patent application and satisfactorily solved. In it, a spring element was introduced into the construction that exerts a spring power directed in the direction of the support onto the bursting element and can thus buffer mechanical changes in length.

However, there is a further problem, in particular for the above-cited gas cylinders for motor vehicle fuel, but also for other gas cylinder that are under a high pressure. A reliable release of the safety valve must be ensured not only in the case of a completely filled but also in the case of an almost empty gas cylinder that can still have a residual pressure in the last-cited state of, e.g., “only” 7 bar or even less. Since the valves must also resist counterpressures during operation of, e.g., approximately 300 bar at a filling of the gas cylinder with natural gas and 700 bar at a filling of the gas cylinder with hydrogen and even briefly three times that value for testing purposes, the cross-sectional surface of the closure body is selected to be correspondingly small. Nevertheless, approximately 500 N load the closure body at a diameter of the closure body of 3 mm and an operating pressure of 700 bar and at a diameter of 6 mm and an operating pressure 9 of 300 bar this is even approximately 850 N. The valves must resist these forces (even values three times greater under extreme test conditions), so that practically exclusively O-rings can be used as sealing elastics.

At full loading pressure the force present on the closure body is then also sufficient in the case of a burst bursting body to securely shift the closure body out of the ready position into the release position. However, if the pressure in the gas cylinder has dropped, e.g., to only 7 bar, the force on the closure body is then only approximately 5 N at a diameter of 3 mm. There is a risk here that this force is not sufficient to ensure a reliable release of the safety valve, in particular if the sealing element, especially an O-ring, adheres to the participating sealing surfaces after a rather long operating time.

### PRESENTATION OF THE INVENTION

The present invention therefore has the problem of further developing a safety valve for gas cylinders of the initially cited type in such a manner that a reliable release is ensured even in the case of low pressures in the gas cylinder.

This problem is solved by a safety valve with the features of claim 1.

Advantageous further developments of the invention are indicated in dependent claims 2 to 7.

The essential feature of the invention consists—in distinction to the teaching of the previously unpublished European patent application cited as post-published state of the art—in that the spring element no longer serves only to compensate different thermal expansion but rather actively supports a shifting of the closure body and therewith a freeing of the overflow conduit at the same time in case of a release, i.e., during the bursting of the bursting element. This is especially significant when, e.g., in case of a fire in a motor vehicle with a gas cylinder as fuel tank this gas cylinder is filled only with a comparatively low pressure. The pure forces exerted by the compressed gas in the gas cylinder on the closure body can then, as presented above, be only a few newtons and no longer in any case ensure a reliable release of the safety valve, i.e., a secure shifting of the closure body. However, since, e.g., a gas cylinder filled with a combustible gas with 7 bar can absolutely still develop a considerable destroying action in an explosion, a reliable release of the safety valve is of great importance. This is where the spring element acting on a closure body in accordance with the invention is a help, which element can be designed by the selection of its design with a certain release force, preferably a force greater than or equal to 10 N, preferably greater than or equal to 20 N (cf. Claim 2). In other words, it is ensured in this manner that a minimal release force of the safety valve is given independently of a residual filling pressure of the gas cylinder. This minimal release force is selected in such a manner that any counterforces produced by a possible adhering or clamping of a sealing element or also the simple frictional forces of the sealing element can be reliably overcome and that the closure element can be reliably produced.

The safety valve in accordance with the invention can be provided in the framework of the invention for being directly connected to a gas cylinder but also to a line connected to this cylinder.

An advantageous further development provides that the spring element is supported on the one hand on the closure body and on the other hand on a valve housing surrounding the overflow conduit and the outlet conduit and that the support on the valve housing is designed to be free of clamping (claim 3). “Free of clamping” signifies in this connection that the spring element with its end supported on the valve housing can become free from the latter and move relative to the valve housing. This conditions the significant advantage that a spring element can follow an opening path of the closure body and can transfer the release force especially well onto the closure body in this manner.

Possible spring elements are a helical spring such as is characterized in detail in claim 4 and a cup spring according to the features of claim 5.

As a rule, an O-ring is selected to seal the closure body against the overflow conduit (see claim 6) since it represents the most favorable and most reliable sealing means given the conditions of pressure and force to be expected in the gas cylinder. Of course, even other sealing methods such as, e.g., lip seals, are possible.

A glass ampoule is preferred as bursting body since it is a bursting element that releases rapidly, precisely according to the temperature and reliably (claim 7).

Further advantages and features of the safety valve in accordance with the invention result from the following description of the exemplary embodiments shown in the attached figures.

### SHORT DESCRIPTION OF THE ILLUSTRATIONS OF THE DRAWINGS

FIG. 1 shows a first embodiment of a safety valve in accordance with the invention in a sectional view;

FIG. 2 shows a second variant of an embodiment of the safety valve in accordance with the invention in a sectional view comparable to FIG. 1;

FIG. 3 shows a third variation of an embodiment of the safety valve in accordance with the invention also in a sectional view;

FIG. 4 shows a fourth variant of an embodiment of the safety valve in accordance with the invention; and

FIG. 5 show a fifth variant of a safety valve in accordance with the invention in section.

The figures are schematic and not true to scale. In the figures the same or similar elements are provided with the same or similarly formed reference numerals.

### WAY(S) OF CARRYING OUT THE INVENTION

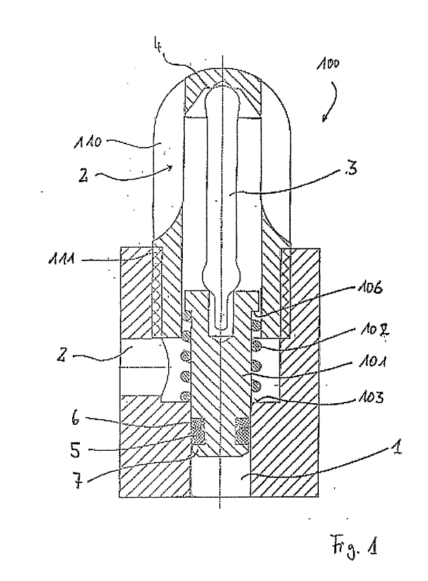

Five differently designed variants of embodiments for a safety valve in accordance with the invention are shown in FIGS. 1 to 5 and are designated there with 100, 200, 300, 400 and 500.

All variants of embodiment shown have the fact in common that they comprise an overflow conduit 1 that is connected in operation to the inner space of a gas cylinder (not shown). Furthermore, all variants of the embodiments shown comprise at least one outlet conduit 2 that is connected to overflow conduit 1 when the safety valve is released, i.e., open, and through which gas flowing out of the gas cylinder then flows out. Furthermore, all variants of the safety valve comprise a closure body designated in the exemplary embodiments with 101, 201, 301, 401 and 501 that closes overflow conduit 1 in a ready position and is held in this ready position by a liquid-filled glass ampoule 3 clamped in between the closure body and a support 4. The liquid-filled glass ampoule 3 receives the forces loading the closure body 101, 201, 301, 401 and 501 by the compressed gas present in overflow conduit 1.

In order to seal the overflow conduit 1 in the ready position the closure bodies have a seal in the form of at least one O-ring 5 in all five exemplary embodiments shown that is fixed by a holding projection 7 on the closure body and is additionally held in its position in any case in the exemplary embodiments according to FIGS. 1 to 4 by a support ring 6.

Furthermore, all exemplary embodiments have the fact in common that they comprise a spring element that is differently designed in the exemplary embodiments and has two functions:

Firstly, the spring element exerts a pre-tension in the direction of support 4 on glass ampoule 3 that serves to catch different material expansions due to fluctuations of temperature and to receive forces that would otherwise exert mechanical tensions on glass ampoule 3. Secondly, the spring element serves to exert a pre-tension on the closure body in a direction of opening, i.e., on support 4. This will become clear once more in the following using the description of each of the individual exemplary embodiments.

In the exemplary embodiment shown in FIG. 1 the closure body 101 is inserted directly into an overflow conduit 1 formed, e.g., in a valve armature and glass ampoule 3 is inserted by a hood 110 containing support 4 via a screw coupling into the valve armature in order to form the safety valve 100 in this manner.

Closure body 101 is pre-tensioned in this exemplary embodiment by a helical spring 102. In addition to this, closure body 101 can in principle move freely in overflow conduit 1, that is, it is arranged in floating manner. Helical spring 102 is placed between a projection 103 in a transitional region between overflow conduit 1 and outlet conduit 2 and rests on the other hand on a projection 106 of closure body 101 in order to apply a spring force on it in this manner.

If glass ampoule 3 breaks due to a high temperature and the associated expansion of the liquid located in glass ampoule 3, in addition to the force exerted by the gas pressure of the compressed gas present in overflow conduit 1 on closure body 101 the force of spring 102 also results in a shifting of closure body 101 in the direction of support 4, as a result of which a communication is opened between overflow conduit 1 and outlet conduit 2 and the gas present in the gas cylinder can therefore flow out via outlet conduit 2. In this exemplary embodiment shown, closure body 101 moves into the interior of hood 110 upon a release, so that the gas can flow off from the gas cylinder via one of outlet conduits 2.

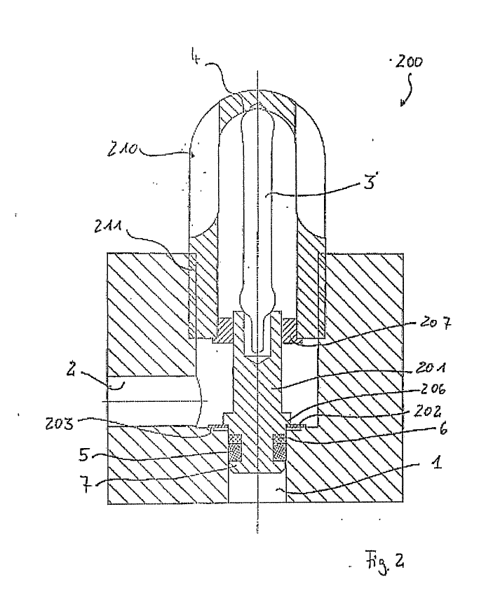

In the exemplary embodiment shown in FIG. 2 a cup spring 202 is selected as spring element which rests on the one hand on a projection 203 in the transitional region between overflow conduit 1 and outlet conduit 2 and on the other hand on a projection 206 of closure body 201. Closure body 201 is additionally guided via a guide ring 207 inserted in hood 210 with support 4. Even in this exemplary embodiment hood 210 is screwed via a screw coupling into an actual valve armature and closure body 201 is inserted directly into overflow conduit 1. Upon a bursting of glass ampoule 3 in this exemplary embodiment in addition to the gas pressure of the compressed gas present in overflow conduit 1 the force of cup spring 202 ensures a reliable release of closure body 201, during which closure body 201 moves in a guided manner in guide ring 207 into hood 210 and comes to rest there in a substantially gas-tight position. Thus, in this exemplary embodiment when there is a release of the safety valve in any case the by far greatest part of the compressed gas flowing off via overflow conduit 1 is removed via outlet conduit 2 and can be conducted from there, e.g., via a connected flowoff line to a purposeful discharge location.

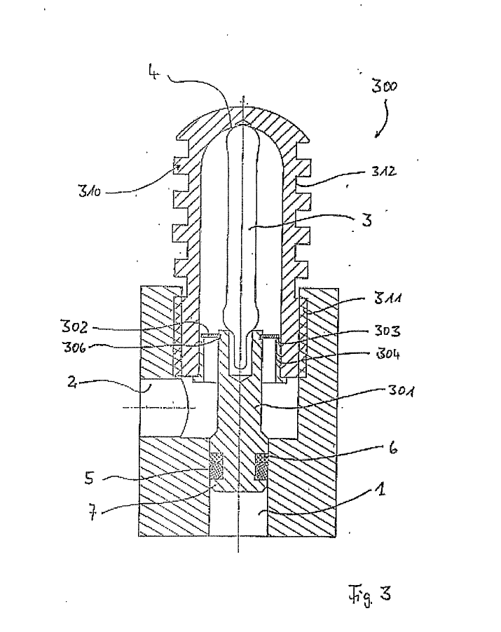

In the exemplary embodiment shown in FIG. 3 the spring element is again a cup spring 302. This cup spring rests on a projection 303 that is formed by the front surfaces of a casing 304 inserted into hood 310 and is fixed on the other hand in an annular groove 306 and closure body 301. Here too, when glass ampoule 3 bursts, in addition to the pressure of the compressed gas present in overflow conduit 1 a pre-tension of cup spring 302 results in a shifting of closure body 301 in the direction of support 4, during which cup spring 302 travels with closure body 301 since it is connected to it via the fit in annular groove 306. Even in this exemplary embodiment the path of the compressed gas after a release of the safety valve via the overflow conduit into the outlet conduit is given since hood 310 comprises no slots for the introduction of the temperature into the interior of the hood, in distinction to the previous examples, but rather is closed. Instead, notches 312 or grooves are introduced into hood 310 here for a better absorption of heat.

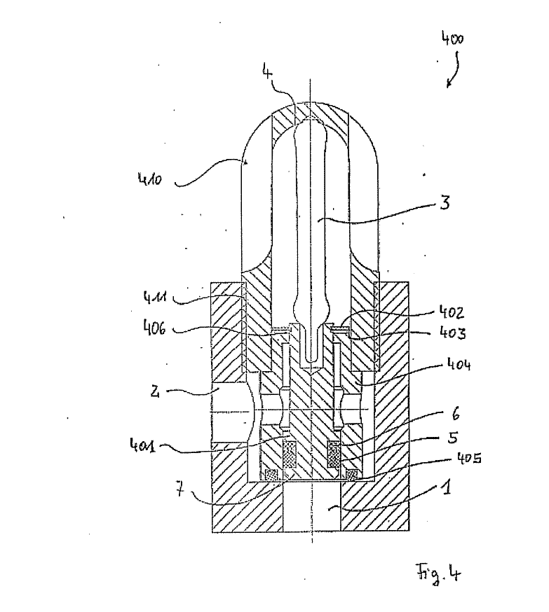

In the exemplary embodiment shown in FIG. 4 the spring element is again a cup spring 402 that rests on the one hand on a shoulder 403 formed by a front surface of an intermediate piece 404 and on the other hand is fixed in an annular groove formed in closure body 401.

Intermediate piece 404 additionally present in this exemplary embodiment serves together with closure body 402, hood 410 to form a compact structural unit that can be screwed via screw coupling 411 into an existing valve armature. This facilitates in particular an assembly. Whereas in particular in the exemplary embodiments shown in FIGS. 1 and 2 the closure body is inserted separately into the overflow conduit and subsequently must be fixed by the hood in order to introduce the glass ampoule, here only a common structural unit has to be placed. In order to prevent a flowing out of compressed gas from overflow conduit 1 into outlet conduit 2 in the ready position already, an additional seal is ensured by O-ring 405 between intermediate piece 404 and a transitional region between overflow conduit 1 and outlet conduit 2. Even in this exemplary embodiment the spring power of cup spring 402 supports a release of closure body 401 upon a bursting of glass ampoule 3.

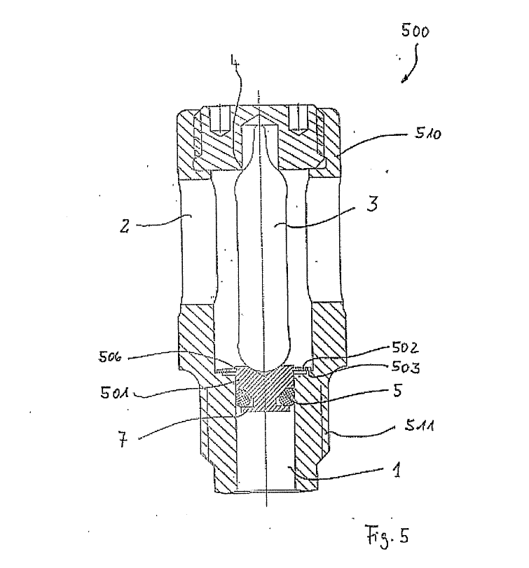

Finally, a similar situation applies to the exemplary embodiment shown in FIG. 5. Here, only one valve construction set is shown that is to be screwed into a valve armature, comprises an outer threading 511 for a connection to the valve armature and is surrounded by a housing piece 510. Here too a cup spring 502 rests on a projection 503 inside housing piece 510 and is on the other hand inserted in an annular groove 506 of closure body 501. Support 4 is screwed into housing piece 51 in a fitting piece. This serves only for assembly purposes since closure body 501 with O-ring 5 and cup spring 502 as well as glass ampoule 3 are inserted into housing piece 510 via this access that is screwed in the finished state.

Cup spring 502 also supports a release and shifting of closure body 501 in this exemplary embodiment upon a bursting of glass ampoule 3. In distinction to the previous examples, here outlet conduit 2 is not a defined conduit located inside an armature but rather is simply formed by an opening in housing piece 50.

All exemplary embodiments shown have the fact in common that they comprise a spring element (helical spring 102, cup springs, 202, 302, 402 and 502) that can be fixed on the particular closure body but can freely move relative to a surrounding housing or comparable element. The particular spring elements exercise a force on the particular closure body that is directed in the direction of support 4 and is sufficiently large in order to move closure body 1 counter to possible forces of adhesion or friction existing on account of the resting of O-ring 5 on the wall of overflow conduit 1 out of the ready position in which it closes overflow conduit 1 into a release position even given an extremely low gas pressure in overflow conduit 1. This ensures in any case that the safety valve in accordance with the invention is reliably released in the case of a high temperature and a correspondingly broken glass ampoule 3.

The exemplary embodiments shown in the figures and described above serve only to explain and are not intended to limit the invention as it is described in the following claims.

### LIST OF REFERENCE NUMERALS

1 overflow conduit, 2 outlet conduit
3 glass ampoule, 4 support
5 O-ring, 6 support ring
7 holding projection
100 safety valve, 101 closure body
102 helical spring, 103 projection
106 projection, 110 hood
111 screw coupling
200 safety valve, 201 closure body
202 cup spring, 203 projection
206 projection, 207 guide ring
210 hood, 211 screw coupling
300 safety valve, 301 closure body
302 cup spring, 303 projection
304 casing, 306 annular groove
310 hood, 311 screw coupling
312 notch
400 safety valve, 401 closure body
402 cup spring, 403 projection
404 intermediate piece, 405 O-ring
406 annular groove, 410 hood
411 screw coupling
500 safety valve, 501 closure body
502 cup spring, 503 projection
506 annular groove, 510 housing piece
511 threading

1. A safety valve for a gas cylinder comprising:
an overflow conduit connected to the gas cylinder;
at least one outlet conduit;
a thermal release unit that comprises:
a closure body that is able to be shifted out of a ready position in which it keeps the overflow conduit tightly closed relative to the at least one outlet conduit in cooperation with a sealing element, and;
a bursting body that is arranged between a support and the closure body in order to hold the closure body in the ready position; and wherein the thermal release unit further includes:
a spring element that exerts a spring force on the bursting body that is oriented in the direction of the support and the spring element acts on the closure body in order to exert a spring force on the closure body that is oriented in a release direction.

2. The safety valve according to claim 1, wherein the spring element applies a release force on the closure body of greater than or equal to 10N, when in the ready position.

3. The safety valve according to claim 1, wherein the spring element is supported on the one hand on the closure body and on the other hand on a valve housing surrounding the overflow conduit and the outlet conduit, and wherein said support on the valve housing is designed to be free of clamping.

4. The safety valve according to claim 1, wherein the spring element is a helical spring resting on the closure body on the one hand and on the other hand on a section of a valve housing comprising the overflow conduit and the outlet conduit.

5. The safety valve according to claim 1, wherein the spring element comprises at least one cup spring resting on the one hand on the closure body and on the other hand on a section of a valve housing comprising the overflow conduit and the outlet conduit.

6. The safety valve according to claim 1, wherein the sealing element is an O-ring resting on the closure body and sealing the overflow conduit in the ready position.

7. The safety valve according to claim 1, wherein the bursting body is a liquid-filled glass ampoule clamped axially in between the closure body and the support.

8. The safety valve according to claim 2, wherein the spring element applies a release force on the closure body of greater than or equal to 20N when in the ready position.
